(19) United States
(12) Patent Application Publication
(10) Pub. No.: US 2026/0251581 A1
(43) Pub. Date: Aug. 27, 2026

(54) DEFECT DETECTION SYSTEM AND OPERATION METHOD THEREOF

(71) Applicant: LITE-ON TECHNOLOGY CORPORATION, Taipei (TW)

(72) Inventors: Yan-Wei LIU, Taipei (TW); Hsuan-Ta LIN, Taipei (TW); Kun-Da LIN, Taipei (TW); Tsung-Hung TSAI, Taipei (TW); I-Hsuan LIN, Taipei (TW); Tse-Chun WANG, Taipei (TW); Wei-Jyun CHEN, Taipei (TW)

(21) Appl. No.: 19/325,690

(22) Filed: Sep. 11, 2025

Related U.S. Application Data
(60) Provisional application No. 63/762,135, filed on Feb. 24, 2025.

(30) Foreign Application Priority Data
Jun. 19, 2025 (CN) 202510822964.2

(51) Int. Cl. G01N 21/88

(52) U.S. Cl. CPC G01N 21/8851; G01N 2021/8854; G01N 2201/121; G01N 2201/129

(57) ABSTRACT

A defect detection system and an operation method thereof are provided. The operation method of the defect detection system includes the following steps. A plurality of existing object images are obtained. The existing object images include a plurality of training existing object images. A plurality of generated object images without defects are generated according to the training existing object images. A main classification model is trained by using the training existing object images and the generated object images.

This application claims the benefit of U.S. Provisional application Ser. No. 63/762,135, filed Feb. 24, 2025 and China application Serial No. 202510822964.2, filed Jun. 19, 2025, the disclosure of which is incorporated by reference herein in its entirety.

### TECHNICAL FIELD

The disclosure relates in general to a detection system and an operation method thereof, and more particularly to a defect detection system and an operation method thereof.

### BACKGROUND

Current defect detection technologies on production lines may employ methods such as manual inspection, automated optical inspection (AOI), machine learning, or deep learning. However, each method has significant limitations. For example, manual inspection is not only inefficient but also susceptible to subjective factors, leading to errors in judgment. AOI systems often rely on preset rules and have poor adaptability to new components or unknown defect types, often resulting in overkill. Traditional machine learning requires manual feature engineering, making it difficult to fully capture abnormal characteristics. While deep learning offers superior automatic learning capabilities, it relies heavily on large amounts of labeled data and faces detection bottlenecks for new, unseen defect types. Furthermore, model training and deployment cycles are lengthy, taking an average of five months to launch, resulting in overall inefficiency and difficulty meeting the demands of rapid implementation and ongoing maintenance within production lines.

Given that current technologies lack the ability to achieve both high accuracy and rapid adaptability, there is an urgent need to develop highly adaptable and efficient intelligent inspection methods to address the challenges of new components and unknown defects. This method must effectively reduce reliance on large amounts of annotated data and enable rapid deployment and dynamic adjustment, improving model maintainability and timeliness. Furthermore, to meet stringent inspection standards for the overkill rate and the underkill rate, the technology must be able to accurately identify subtle differences and instantly correct misjudgments. Consequently, production lines urgently need next-generation intelligent inspection technology that integrates efficient inference capabilities, self-learning mechanisms, and adaptability to small sample sizes.

### SUMMARY

This disclosure relates to a defect detection system and an operating method thereof. By combining a confidence check unit with a main classification model, it effectively reduces the underkill rate while maintaining the overkill rate below a certain level. Furthermore, increasing the amount of training data helps improve the performance of the main classification model.

According to one embodiment, an operation method of a defect detection system is provided. The operation method of the defect detection system includes the following steps. A plurality of existing object images are obtained. The existing object images include a plurality of training existing object images. A plurality of generated object images are generated according to the training existing object images without defects. A main classification model is trained by using the training existing object images and the generated object images.

According to another embodiment, a defect detection system includes a database and a training module. The database is used for storing a plurality of existing object images. The existing object images include a plurality of training existing object images. The training module includes a generative model and a training unit. The generative model is used for generating a plurality of generated object images according to the training existing object images without defects. The training unit is used for training a main classification model by using the training existing object images and the generated object images.

### BRIEF DESCRIPTION OF THE DRAWINGS

FIG. 1 illustrates a schematic diagram of a defect detection system according to an embodiment of the present disclosure.

FIG. 2 illustrates the overkill rate and the underkill rate.

FIG. 3 illustrates the five stages of the operation of the defect detection system according to one embodiment of the present disclosure.

FIG. 4 illustrates data acquisition.

FIG. 5 illustrates a detailed flowchart of the step S400 according to one embodiment of the present disclosure.

FIG. 6 illustrates a detailed flowchart of the step S500 according to one embodiment of the present disclosure.

FIG. 7 illustrates a detailed flow chart of the step S550 according to an embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

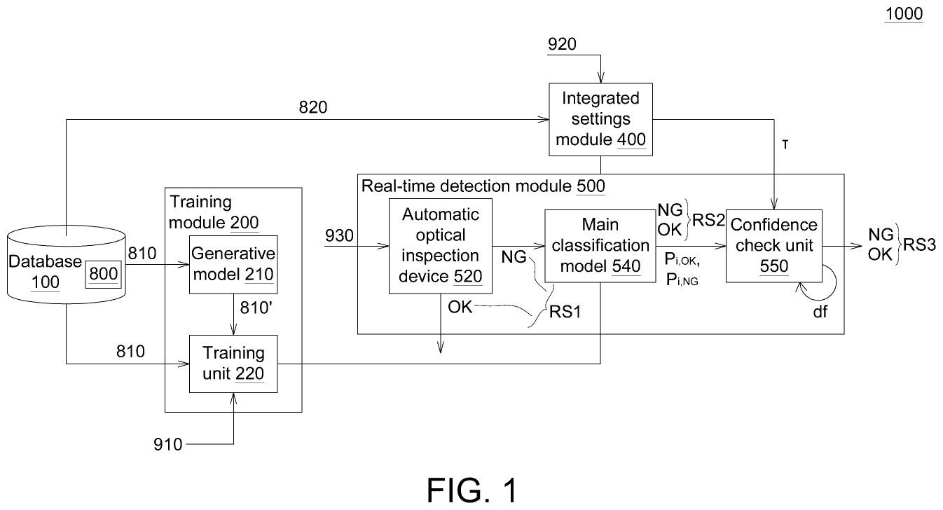

Please refer to FIG. 1, which illustrates a schematic diagram of a defect detection system 1000 according to an embodiment of the present disclosure. The defect detection system 1000 is, for example, a circuit board defect detection system or an object defect detection system on a production line. The defect detection system 1000 disclosed herein comprises a database 100, a training module 200, a real-time detection module 500, and an integrated settings module 400. The functions of each component are summarized below. The database 100 is used to store various data, such as (but not limited to) memory, hard drives, or cloud storage centers. The training module 200 includes a generative model 210 and a training unit 220. The generative model 210 is used to expand the sample. The generative model 210 may be, for example (but not limited to), a Generative Adversarial Network (GAN), a Variational Autoencoders (VAE), an Autoregressive Models, a Diffusion Models, or an Energy-Based Models (EBM). The training unit 220 is used to train the model. The training unit 220 may employ, for example (but not limited to), techniques such as Class Balanced Sampler, ReduceLROnPlateau Scheduler, SymmetricCrossEntropy Loss, Label Smoothing, Loss Weighting, and Semi-supervised Learning.

The Class Balanced Sampler addresses class imbalance, preventing the model from biasing its predictions towards the majority class. The ReduceLROnPlateau Scheduler dynamically adjusts the learning rate based on validation set metrics, accelerating model convergence. The SymmetricCrossEntropy Loss addresses label noise and overconfidence, improving model robustness. The Label Smoothing smooths sample labels in the training set, preventing overconfidence and enhancing generalization. The Loss Weighting could be set to 2 for the Normal class and 15 for the Abnormal class, further strengthening the model's ability to discern abnormal classes. The Semi-supervised Learning is supplemented by training the model on a small number of test samples collected over N days to enhance classification performance.

The real-time detection module 500 includes an automated optical inspection (AOI) device 520, a main classification model 540, and a confidence check unit (or called Prediction Confidence Inspection System, PCIS) 550. The automatic optical inspection device 520 utilizes optical imaging and image processing technology to automatically inspect products for surface defects or structural anomalies. Examples of the automatic optical inspection device 520 include, but are not limited to, color AOI, coaxial AOI, oblique AOI, oblique AOI, or backlit oblique AOI.

The main classification model 540 is used to further infer a detection result RS1 of the automatic optical inspection device 520 to obtain an auxiliary inference result RS2.

The confidence check unit 550 is used to confirm the correctness of the auxiliary inference result RS2 to obtain a corrected inference result RS3.

The integrated settings module 400 integrates and configures the real-time detection module 500 so that the combination of the main classification model 540 and the confidence check unit 550 could reduce the underkill rate R2 and maintain the overkill rate R1 below a certain level.

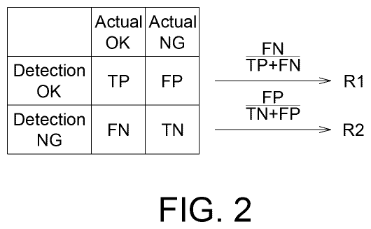

Refer to FIG. 2, which illustrates the overkill rate R1 and the underkill rate R2. In defect detection for the circuit boards and the finished products, there are four scenarios: true positive TP, false positive FP, true negative TN, and false negative FN. The overkill rate R1 could be calculated using equation (1), while the underkill rate R2 could be calculated using equation (2).

$$overkill rate R 1 = \frac{false negative FN}{true positive TP + false negative FN} \qquad ( 1 )$$

$$underkill rate R 2 = \frac{false positive FP}{true negative TN + false positive FP} \qquad ( 2 )$$

The training module 200 (and the generative model 210 and the training unit 220 thereof), the real-time detection module 500 (and the main classification model 540 and the confidence check unit 550 thereof), and/or the integrated settings module 400 is, for example, a circuit, a circuit board, a storage device storing program code, or a chip. The chip is, for example, a central processing unit (CPU), a programmable general-purpose or special-purpose micro control unit (MCU), a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), an embedded system, a field programmable gate array (FPGA), other similar element or a combination thereof.

By utilizing these components, the high-precision defect detection system 1000 disclosed herein addresses existing issues such as insufficient detection capabilities for new components and unknown defects, excessively high underkill rates R2, the time required to collect annotated data, and a lack of real-time correction mechanisms. By integrating a confidence check unit 550 with an optimized main classification model 540, this technology effectively reduces the underkill rate R2 to below 0.2% while maintaining the overkill rate R1 below 20%. For example, the defect detection system 1000 disclosed herein utilizes data augmentation techniques such as generative adversarial networks and model training techniques such as semi-supervised learning to reduce reliance on labeled data. This significantly reduces the time it takes to launch the main classification model 540 from five months to ten days. The confidence check unit 550 also enables real-time correction of prediction results, improving detection efficiency. Experiments have shown that increasing data volumes significantly improves the performance of the main classification model 540, and that, with sufficient data, the confidence check unit 550 could significantly reduce the underkill rate R2, demonstrating the high accuracy and efficiency of this technology.

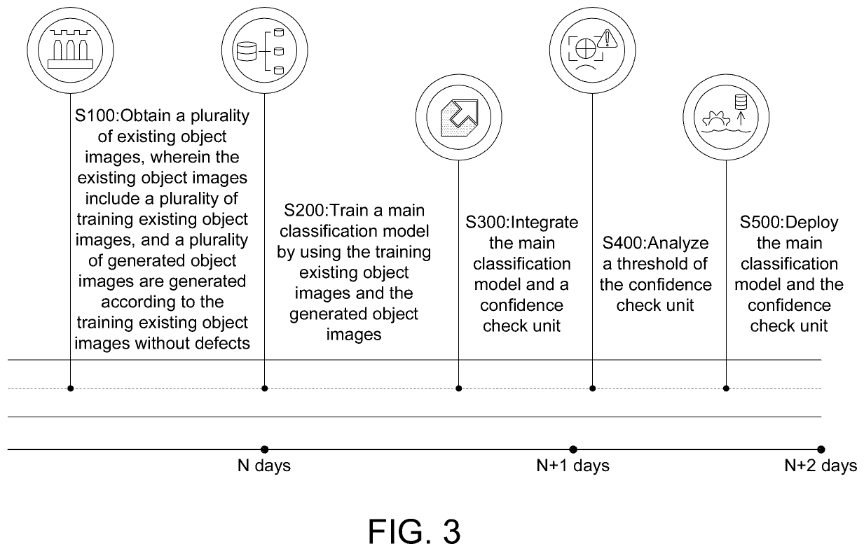

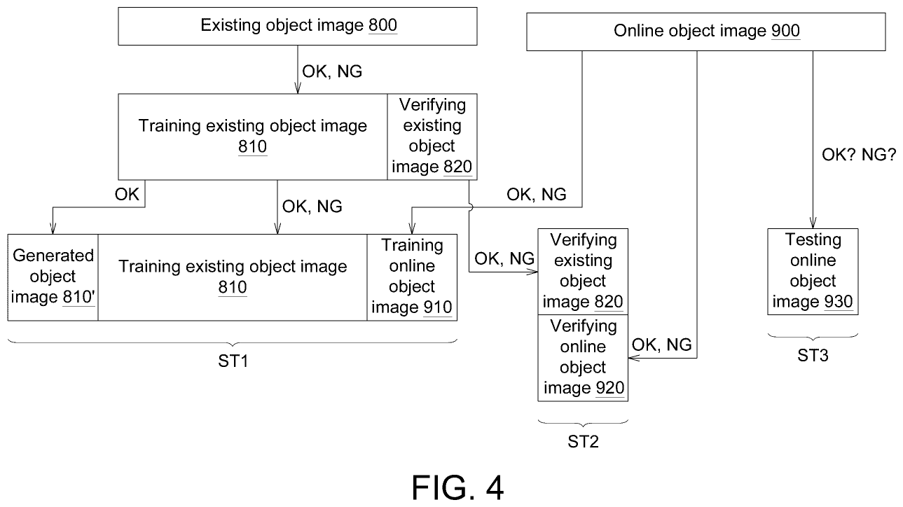

Please refer to FIGS. 3 and 4. FIG. 3 illustrates the five stages of the operation of the defect detection system 1000 according to one embodiment of the present disclosure. FIG. 4 illustrates data acquisition. As shown in FIG. 4, a plurality of existing object images 800 are available from the database 100. The object images 800 may be images of circuit boards or manufactured products, for example. The existing object images 800 are labeled “OK” or “NG.” The “OK” label indicates that the existing object image 800 has no defect; the “NG” label indicates that the existing object image 800 has defects.

The existing object images 800 are categorized into a plurality of training existing object images 810 and a plurality of verifying existing object images 820. The training existing object images 810, for example, are images of existing circuit boards or existing production products for training. The verifying existing object images 820, for example, are images of existing circuit boards or existing production products being verified. The training existing object images 810 account for 70 to 90% of the existing object images 800, for example, but not limited to, 80%. The verifying existing object images 820 account for 10 to 30% of the existing object images 800, for example, but not limited to, 20%.

The portions of the training existing object images 810 marked “OK” are used to generate a plurality of generated object images 810′ and included in a training dataset ST1. The generated object images 810′ may be images of printed circuit boards or finished products, for example. All of the training existing object images 810 marked “OK” or “NG” are included in training dataset ST1. All of the verifying existing object images 820 marked “OK” or “NG” are included in a validation dataset ST2.

A plurality of online object images 900 are also captured on the production line. The online object images 900 are, for example, images of online circuit boards or products. The online object images 900 include a plurality of training online object images 910, a plurality of verification online object images 920, and a plurality of testing online object images 930. The training online object images 910 are, for example, images of online circuit boards or products used for training. The verifying online object images 920 are, for example, images of circuit boards or production products being verified. The testing online object images 930 are, for example, images of circuit boards or production products being tested. The training online object images 910 and the verifying online object images 920 are labeled “OK” or “NG.” An “OK” label indicates that the training online object image 910 or the verifying online object image 920 has no defects; an “NG” label indicates that the training online object image 910 or the verifying online object image 920 has defects.

All of the training online object images 910 labeled “OK” or “NG” are included in the training dataset ST1. All of the verifying online object images 920 labeled “OK” or “NG” are included in the validation dataset ST2. The unlabeled testing online object images 930 are included in a testing dataset ST3.

As shown in FIG. 3, the operation method of the defect detection system 1000 includes five stages such as step S100 to S500.

In the step S100, the “data collection and sample image generation phase,” as shown in FIG. 4, the generative model 210 obtains the existing object image 800 from the database 100 and generates the generated object images 810′ according to the existing object image 800. In this step, the generative model 210 uses the training existing object images 810 that have no defect (i.e., “OK”) to generate the generated object images 810′.

In this step, the number of the generated object images 810′ is lower than the number of the existing object images 800, without excessively affecting the distribution of the existing object images 800.

Next, in the step S200, the “model training phase,” as shown in FIG. 4, the main classification model 540 is trained according to the existing object images 810, the generated object images 810′, and the online object images 910 (if applicable). The training unit 220 trains the model using, for example (but not limited to), the MobileNetV3 Large architecture, the employing optimization techniques, the learning rate adjustments, the loss functions, the sample sampling, and the data augmentation.

Next, in the step S300, the “PCIS integration setup phase,” as shown in FIG. 1, the integrated settings module 400 integrates the main classification model 540 and the confidence check unit 550. As shown in FIG. 1, the integrated settings module 400 integrates the automatic optical inspection device 520, the main classification model 540, and the confidence check unit 550 in this order. This allows the testing online object image 930 to be inspected sequentially by the automatic optical inspection device 520, the main classification model 540, and the confidence check unit 550 to accurately detect defects.

Then, in the step S400, the “PCIS threshold t setting phase,” as shown in FIG. 1, the integrated settings module 400 analyzes the threshold t of the confidence check unit 550.

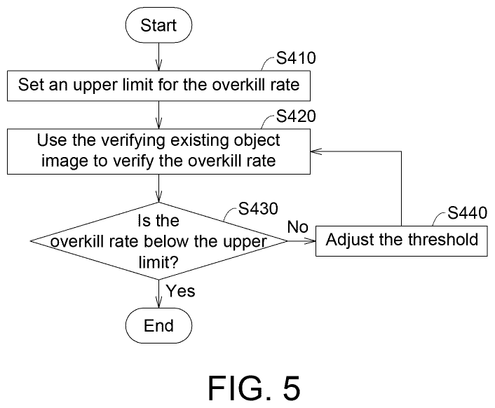

Please refer to FIG. 5, which illustrates a detailed flowchart of the step S400 according to one embodiment of the present disclosure. The step S400 includes, for example, but not limited to, steps S410 to S440. In the step S410, the integrated settings module 400 sets an upper limit for the overkill rate R1. The upper limit is, for example, but not limited to, 22%.

Next, in the step S420, the integrated settings module 400 uses the verifying existing object image 820 and the verifying online object image 920 (if any) to verify the overkill rate R1. The overkill rate R1 is calculated, for example, according to the above equation (1).

Then, in the step S430, the integrated settings module 400 determines whether the overkill rate R1 is below the upper limit. If so, the process is terminated; If not, the process proceeds to the step S440.

In the step S440, the integrated settings module 400 adjusts the threshold t to reduce the overkill rate R1. The steps S420 to S440 are repeated until the overkill rate R1 falls below the upper limit, at which the threshold t is no longer adjusted.

Next, in the step S500 of FIG. 3, the integrated settings module 400 deploys the main classification model 540 and the confidence check unit 550 on the production line.

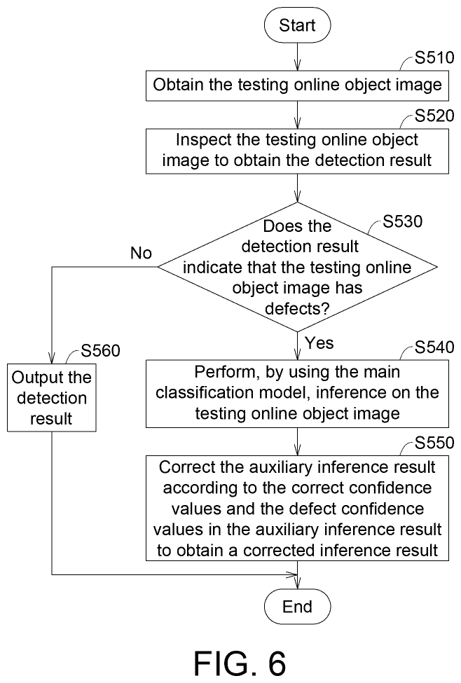

Please refer to FIG. 6, which illustrates a detailed flowchart of the step S500 according to one embodiment of the present disclosure. The step S500 includes, for example (but not limited to), steps S510 to S560.

In the step S510, as shown in FIG. 1, the testing online object image 930 is obtained.

Next, in the step S520, as shown in FIG. 1, the automatic optical inspection device 520 inspects the testing online object image 930 to obtain the detection result RS1. The detection result RS1 includes a result indicating that the testing online object image 930 has defects (i.e., “NG”) and a result indicating that the testing online object image 930 has no defect (i.e., “OK”).

Next, in the step S530, as shown in FIG. 1, whether the detection result RS1 indicates that the testing online object image 930 has defects is determined. If the detection result RS1 indicates “the testing online object image 930 has defects (i.e., “NG”),” the process proceeds to the step S540. If the detection result RS1 indicates “the testing online object image 930 have no defect (i.e., “OK”),” the process proceeds to the step S560.

In the step S560, as shown in FIG. 1, the detection result RS1 is output. Specifically, when the automatic optical inspection device 520 detects that the testing online object image 930 has no defect (i.e., “OK”), it directly outputs the detection result RS1 as “OK.”

In the step S540, as shown in FIG. 1, the main classification model 540 is used to perform inference on the testing online object image 930 to obtain the auxiliary inference result RS2. The auxiliary inference result RS2 includes a result indicating that the testing online object image 930 has defects (i.e., “NG”) and a result indicating that the testing online object image 930 have no defect (i.e., “OK”). When the main classification model 540 outputs the auxiliary inference result RS2, it is accompanied by a correct confidence level P_{i,OK} and a defect confidence level P_{i,NG}. This means that the “NG” detection result RS1 might be corrected to the “OK” auxiliary inference result RS2 after inference by the main classification model 540; conversely, the “NG” detection result RS1 might be maintained as the “NG” auxiliary inference result RS2 after inference by the main classification model 540.

Next, in the step S550, as shown in FIG. 1, the confidence check unit 550 corrects the auxiliary inference result RS2 according to the correct confidence values P_{i,OK} and the defect confidence values P_{i,NG} in the auxiliary inference result RS2 to obtain a corrected inference result RS3. The corrected inference result RS3 includes the results “The testing online object image 930 has defects (i.e., “NG”)” and “The testing online object image 930 have no defect (i.e., “OK”).”

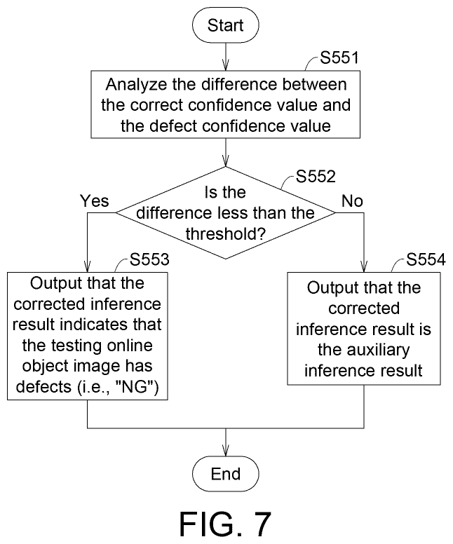

Please refer to FIG. 7, which illustrates a detailed flow chart of the step S550 according to an embodiment of the present disclosure. The step S550 includes, for example, (but is not limited to) steps S551 to S554, to perform the operation of the following formula (3).

$$∀ i ∈ \{ 1 , 2 , … , N \} , {\hat{y}}_{def} = \{ \begin{matrix}NG & if \vert {p}_{i , OK} - {p}_{i , NG} \vert < τ \\ arg max \{ {p}_{i , OK} , {p}_{i , NG} \} & otherwise\end{matrix} \qquad ( 3 )$$

ŷ_{def} is the corrected inference result RS3.

In the step S551, as shown in FIG. 1, the confidence check unit 550 analyzes the difference df (i.e., |p_{i,OK}−p_{i,NG}|) between the correct confidence value P_{i,OK} and the defect confidence value P_{i,NG}.

Next, in the step S552, whether the difference df is less than the threshold t is determined. If the difference df is less than threshold t, the process proceeds to the step S553. If the difference df is greater than or equal to threshold t, the process proceeds to the step S554.

In the step S553, the confidence check unit 550 outputs that the corrected inference result RS3 indicates that the testing online object image 930 has defects (i.e., “NG”). In other words, if the difference df is less than the threshold t, the “OK” auxiliary inference result RS2 may need to be changed to the “NG” corrected inference result RS3 after verification by the confidence check unit 550.

In the step S554, the confidence check unit 550 outputs that the corrected inference result RS3 is the auxiliary inference result RS2. In other words, if the difference df is greater than or equal to the threshold t, the “OK” or “NG” auxiliary inference result RS2 is deemed not to require modification after verification by the confidence check unit 550.

According to the step S500 and its sub steps, when the automatic optical inspection device 520 detects that the testing online object image 930 has defects (i.e., “NG”), the main classification model 540 first infers whether it is possible that the testing online object image 930 have no defect (i.e., “OK”). If the main classification model 540 infers that the testing online object image 930 have no defect (i.e., “OK”) and the difference df between the correct confidence level P_{i,OK} and the defect confidence level P_{i,NG} exceeds the threshold t, the classification model 540 may be changed to “the testing online object image 930 have no defect (i.e., “OK”).”

Based on the above-described embodiments, the disclosed defect detection system 1000 and its operating method could improve the defect detection accuracy, particularly for new and unseen PCBA components with solder defects, while also reducing the need for manual re-inspection at the factory. As shown in FIG. 3, the system rollout process takes only N+2 days, consisting of N days of data collection, 1 day of model training, and 1 day of deployment.

By combining the confidence check unit 550 with the main classification model 540, this technology effectively reduces the underkill rate R2 to below 0.2%, while maintaining the overkill rate R1 below 20%. Furthermore, the confidence check unit 550 enables the real-time correction of the prediction results, improving the detection efficiency. Furthermore, increasing the amount of the training data improves the performance of the main classification model 540. With sufficient data, the confidence check unit 550 could significantly reduce the underkill rate R2, demonstrating the high accuracy and efficiency of this technology.

The above disclosure provides various features for implementing some implementations or examples of the present disclosure. Specific examples of components and configurations (such as numerical values or names mentioned) are described above to simplify/illustrate some implementations of the present disclosure. Additionally, some embodiments of the present disclosure may repeat reference symbols and/or letters in various instances. This repetition is for simplicity and clarity and does not inherently indicate a relationship between the various embodiments and/or configurations discussed.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. An operation method of a defect detection system, comprising:
obtaining a plurality of existing object images, wherein the existing object images include a plurality of training existing object images, and a plurality of generated object images are generated according to the training existing object images without defects; and
training a main classification model by using the training existing object images and the generated object images.

2. The operation method of the defect detection system according to claim 1, wherein number of the generated object images is lower than number of existing object images.

3. The operation method of the defect detection system according to claim 1, further comprising:
integrating the main classification model and a confidence check unit;
analyzing a threshold of the confidence check unit; and
deploying the main classification model and the confidence check unit.

4. The operation method of the defect detection system according to claim 3, wherein the existing object images include a plurality of verifying existing object images, the step of analyzing the threshold of the confidence check unit includes:
setting an upper limit for the overkill rate;
obtaining the overkill rate by using the verifying existing object images;
determining whether the overkill rate is lower than the upper limit; and
adjusting the threshold, if the overkill rate is higher than or equal to the upper limit.

5. The operation method of the defect detection system according to claim 4, wherein the verifying existing object images account for 10 to 30% of the existing object images.

6. The operation method of the defect detection system according to claim 4, wherein the upper limit is 22%.

7. The operation method of the defect detection system according to claim 3, wherein the step of deploying the main classification model and the confidence check unit includes:
obtaining a testing online object image;
detecting, by an automatic optical inspection device, the testing online object image to obtain a detection result;
determining whether the detection result indicates that the testing online object image has defects;
inferring, by the main classification model, the testing online object image to obtain an auxiliary inference result, if the detection result is that the testing online object image has defects; and
correcting, by the confidence check unit, the auxiliary inference result to obtain a corrected inference result according to a correct confidence and a defect confidence of the auxiliary inference result.

8. The operation method of the defect detection system according to claim 7, wherein the step of correcting, by the confidence check unit, the auxiliary inference result to obtain the corrected inference result according to the correct confidence and the defect confidence of the auxiliary inference result includes:
analyzing a difference between the correct confidence and the defect confidence;
determining whether the difference is less than the threshold; and
deeming that the corrected inference result indicates that the testing online object image has defects, if the difference is less than the threshold.

9. The operation method of the defect detection system according to claim 8, wherein the step of correcting, by the confidence check unit, the auxiliary inference result to obtain the corrected inference result according to the correct confidence and the defect confidence of the auxiliary inference result includes:
setting the corrected inference result to the auxiliary inference result, if the difference is greater than or equal to the threshold.

10. A defect detection system, comprising:
a database, used for storing a plurality of existing object images, wherein the existing object images include a plurality of training existing object images; and
a training module, comprising:
a generative model, used for generating a plurality of generated object images according to the training existing object images without defects; and
a training unit, used for training a main classification model by using the training existing object images and the generated object images.

11. The defect detection system according to claim 10, wherein number of the generated object images is lower than number of existing object images.

12. The defect detection system according to claim 10, further comprising:
a real-time detection module, including:
an automatic optical inspection device;
the main classification model; and
a confidence check unit, having a threshold; and
an integrated settings module, used for integrating the main classification model and the confidence check unit, and analyzing the threshold of the confidence check unit.

13. The defect detection system according to claim 12, wherein the existing object images include a plurality of verifying existing object images, the integrated settings module is used for setting an upper limit for the overkill rate, obtaining the overkill rate by using the verifying existing object images, and determining whether the overkill rate is lower than the upper limit, if the overkill rate is higher than or equal to the upper limit, the integrated settings module adjusts the threshold.

14. The defect detection system according to claim 13, wherein the verifying existing object images account for 10 to 30% of the existing object images.

15. The defect detection system according to claim 13, wherein the upper limit is 22%.

16. The defect detection system according to claim 12, wherein the automatic optical inspection device is used for obtaining a testing online object image, and detecting the testing online object image to obtain a detection result;
the main classification model is used for inferring the testing online object image to obtain an auxiliary inference result, if the detection result is that the testing online object image has defects; and
the confidence check unit is used for correcting the auxiliary inference result to obtain a corrected inference result according to a correct confidence and a defect confidence of the auxiliary inference result.

17. The defect detection system according to claim 16, wherein the confidence check unit is further used for analyzing a difference between the correct confidence and the defect confidence, and determining whether the difference is less than the threshold;
the confidence check unit is further used for deeming that the corrected inference result indicates that the testing online object image has defects, if the difference is less than the threshold.

18. The defect detection system according to claim 17, wherein the confidence check unit is further used for setting the corrected inference result to the auxiliary inference result, if the difference is greater than or equal to the threshold.
